(19) United States
(12) Patent Application Publication
(10) Pub. No.: US 2025/0214613 A1
(43) Pub. Date: Jul. 3, 2025

(54) AUTONOMOUS VEHICLE SENSOR VISIBILITY MANAGEMENT

(71) Applicant: Aurora Operations, Inc., Pittsburgh, PA (US)

(72) Inventors: James Robert Curry, Bozeman, MT (US); Wai Son Ko, San Jose, CA (US); Bo Li, Pittsburgh, PA (US); Bishwamoy Sinha Roy, Cranberry Township, PA (US); Varun Nagarakere Ramakrishna, Pittsburgh, PA (US)

(21) Appl. No.: 19/002,202

(22) Filed: Dec. 26, 2024

Related U.S. Application Data
(60) Provisional application No. 63/615,709, filed on Dec. 28, 2023.

(51) Int. Cl. B60W 60/00; G06V 10/70

(52) U.S. Cl. CPC B60W 60/001; G06V 10/70; B60W 2420/403; B60W 2420/408

(57) ABSTRACT

Various examples are directed to systems and methods for operating an autonomous vehicle. The autonomous vehicle may access sensor data captured by at least one sensor corresponding to the autonomous vehicle associated with operation of the autonomous vehicle in an environment. The autonomous vehicle generates an output based on the sensor data and with a machine-learned model. The output may characterize the sensor data to indicate a sensor support level in the environment. The machine-learned model may be trained using training data comprising a plurality of instances of logged sensor data depicting examples of a reference object, each instance of the plurality of instances of logged sensor data being associated with a label indicating a range at which the reference object was detected in the instances of logged sensor data. The autonomous vehicle may be controlled based at least in part on the distance or a visibility classification derived from the distance.

### CLAIM FOR PRIORITY

This application claims the benefit of priority of U.S. Provisional Application No. 63/615,709, filed Dec. 28, 2023, which is hereby incorporated by reference in its entirety.

### BACKGROUND

The automobile industry is currently developing autonomous features for controlling vehicles under certain circumstances. According to Society of Automotive Engineers (SAE) International standard J3016, there are 6 levels of autonomy ranging from Level 0 (no autonomy) up to Level 5 (vehicle capable of operation without operator input in all conditions). A vehicle with autonomous features utilizes sensors to sense the environment that the vehicle navigates through. Acquiring and processing data from the sensors allows the vehicle to navigate through its environment.

### DRAWINGS

FIG. 1 is a block diagram of an example operational scenario, according to some implementations of the present disclosure.

FIG. 2 is a block diagram of an example autonomy system for an autonomous platform, according to some implementations of the present disclosure.

FIG. 3A shows an example environment including an example autonomous vehicle.

FIG. 3B is an overhead view of the example environment of FIG. 3A.

FIG. 3C shows another example environment including another example autonomous vehicle.

FIG. 3D is an overhead view of the example environment of FIG. 3C.

FIG. 4 is a diagram showing one example of an environment including an autonomous vehicle traveling on a travel way.

FIG. 5 is a diagram showing another example of the environment of FIG. 4 viewing the autonomous vehicle from a top-down view parallel to the Z axis.

FIG. 6 is a representation of an environment comprising an autonomous vehicle traveling on a roadway in the presence of environmental factors that limit sensor support.

FIG. 7 is a flowchart showing one example of a process flow that may be executed by an autonomous vehicle to operate the autonomous vehicle considering sensor support data.

FIG. 8 is a flowchart showing another example of a process flow that may be executed at an autonomous vehicle to operate the autonomous vehicle considering sensor support data.

FIG. 9 is a diagram showing one example of an environment for training the machine-learned model.

FIG. 10 is a flowchart showing one example of a process flow that may be executed in the environment to train the machine-learned model.

FIG. 11 is a block diagram of an example computing ecosystem according to example implementations of the present disclosure.

### SUMMARY

An autonomous vehicle may operate in a variety of different visibility levels, with different visibility levels. Differing visibility levels may be caused, for example, by weather, smoke, or other similar environmental conditions. Sensors of the autonomous vehicle may perform differently in different weather conditions. For example, it may be more challenging to identify objects using sensor data captured in the presence of precipitation, fog, smoke, or similar environmental conditions.

Various examples described herein are directed to systems and methods of operating an autonomous vehicle. Example 1 is a method of operating an autonomous vehicle, comprising: accessing sensor data captured by at least one sensor corresponding to the autonomous vehicle associated with operation of the autonomous vehicle in an environment, the environment characterized by one or more environmental conditions; generating, based on the sensor data and with a machine-learned model, an output that indicates a sensor support level in the environment, wherein the machine-learned model is trained using training data, the training data comprising a plurality of instances of logged sensor data depicting examples of a reference object, each instance of the plurality of instances of logged sensor data being associated with a label indicating a range at which the reference object was detected in the instances of logged sensor data, and wherein the reference object is not depicted in the sensor data captured by the at least one sensor corresponding to the autonomous vehicle; and controlling the autonomous vehicle based at least in part on sensor support level.

In Example 2, the subject matter of Example 1 optionally includes selecting a distance from a plurality of distances having a corresponding sensor support quantity that meets a detectability threshold, wherein the output of the machine-learned model comprises the plurality of sensor support quantities over a plurality of distances, a first sensor support quantity corresponding to the first distance of the plurality of distances and a second sensor support quantity corresponding to a second distance of the plurality of distances.

In Example 3, the subject matter of Example 2 optionally includes the sensor support quantity indicating at least one of a number of lidar points per unit surface area of the reference object that would be returned, a number of radar points per unit surface area of the reference object that would be returned, a result of applying an object detection mask to a portion of the sensor data depicting the reference object, or a result of a second machine-learned model that is trained to identify the reference object in at least a portion of the sensor data.

In Example 4, the subject matter of any one or more of Examples 2-3 optionally includes the detectability threshold indicating a threshold number of returned points per unit surface area of the reference object.

In Example 5, the subject matter of any one or more of Examples 2-4 optionally includes the sensor data comprising image data captured by a camera, the detectability threshold indicating a threshold result of applying an object detection mask to a portion of the image data.

In Example 6, the subject matter of any one or more of Examples 2-5 optionally includes the sensor data comprising image data captured by a camera, the detectability threshold indicating an output of a second machine-learned model trained to identify the reference object in the image data.

In Example 7, the subject matter of any one or more of Examples 1-6 optionally includes wherein the sensor support level comprises an indication of a visibility classification in the one or more environmental conditions.

In Example 8, the subject matter of Example 7 optionally includes wherein the visibility classification is one of nominal, degraded, or severely degraded.

In Example 9, the subject matter of any one or more of Examples 1-8 optionally includes executing the machine-learned model using at least a portion of the training data as input to generate a training output of the machine-learned model; comparing the training output of the machine-learned model to the label data; and modifying the machine-learned model based at least in part on the comparing of the training output of the machine-learned model to the label data.

In Example 10, the subject matter of any one or more of Examples 8-9 optionally includes each instance of the logged sensor data also being associated with label data indicating a visibility classification for the respective instance of the logged sensor data.

Example 11 is an autonomous vehicle comprising: at least one processor programmed to perform operations comprising: accessing sensor data captured by at least one sensor corresponding to the autonomous vehicle associated with operation of the autonomous vehicle in an environment, the environment characterized by one or more environmental conditions; generating, based on the sensor data and a machine-learned model, an output that indicates a sensor support level in the environment, wherein the machine-learned model is trained using training data, the training data comprising a plurality of instances of logged sensor data depicting examples of a reference object, each instance of the plurality of instances of logged sensor data being associated with a label indicating a range at which the reference object was detected in the instances of logged sensor data, and wherein the reference object is not depicted in the sensor data captured by the at least one sensor corresponding to the autonomous vehicle; and controlling the autonomous vehicle based at least in part on sensor support level.

In Example 12, the subject matter of Example 11 optionally includes the operations further comprising selecting a distance from a plurality of distances having a corresponding sensor support quantity that meets a detectability threshold, wherein the output of the machine-learned model comprises the plurality of sensor support quantities over a plurality of distances, a first sensor support quantity corresponding to a first distance of the plurality of distances and a second sensor support quantity corresponding to the second distance of the plurality of distances.

In Example 13, the subject matter of Example 12 optionally includes the sensor support quantity indicating at least one of a number of lidar points per unit surface area of the reference object that would be returned, a number of radar points per unit surface area of the reference object that would be returned, a result of applying an object detection mask to a portion of the sensor data depicting the reference object, or a result of a second machine-learned model that is trained to identify the reference object in at least a portion of the sensor data.

In Example 14, the subject matter of any one or more of Examples 12-13 optionally includes the detectability threshold indicating a threshold number of returned points per unit surface area of the reference object.

In Example 15, the subject matter of any one or more of Examples 12-14 optionally includes the sensor data comprising image data captured by a camera, the detectability threshold indicating an output of a second machine-learned model trained to identify the reference object in the image data.

In Example 16, the subject matter of any one or more of Examples 12-15 optionally includes the sensor data comprising image data captured by a camera, the detectability threshold indicating an output of a second machine-learned model trained to identify the reference object in the image data.

In Example 17, the subject matter of any one or more of Examples 11-16 optionally includes wherein the sensor support level comprises an indication of a visibility condition in the environment.

In Example 18, the subject matter of any one or more of Examples 11-17 optionally includes the operations further comprising: executing the machine-learned model using at least a portion of the training data as input to generate a training output of the machine-learned model; comparing the training output of the machine-learned model to the label data; and modifying the machine-learned model based at least in part on the comparing of the training output of the machine-learned model to the label data.

In Example 19, the subject matter of any one or more of Examples 17-18 optionally includes each instance of the logged sensor data also being associated with label data indicating a visibility classification for the respective instance of the logged sensor data.

Example 20 is at least one non-transitory computer-readable storage media comprising instructions thereon that, when executed by at least one processor, because the at least one processor to perform operations comprising: accessing sensor data captured by at least one sensor corresponding to an autonomous vehicle associated with operation of the autonomous vehicle in an environment, the environment characterized by one or more environmental conditions; generating, based on the sensor data and a machine-learned model, an output that indicates a distance at which a reference object would meet a detectability threshold in the environment; and controlling the autonomous vehicle based at least in part on the distance or a visibility classification derived from the distance.

### DETAILED DESCRIPTION

The following describes the technology of this disclosure within the context of an autonomous vehicle for example purposes only. As described herein, the technology described herein is not limited to an autonomous vehicle and can be implemented for or within other autonomous platforms and other computing systems.

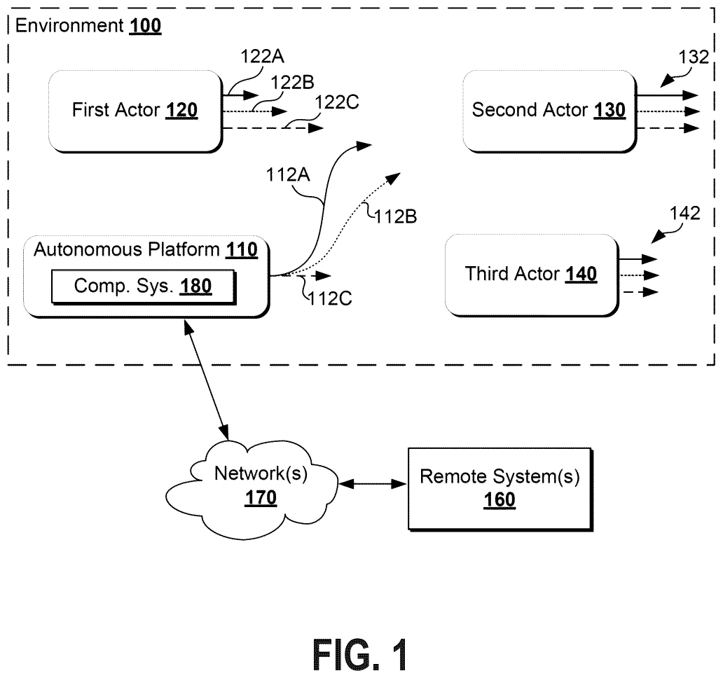

With reference to FIGS. 1-11, example implementations of the present disclosure are discussed in further detail. FIG. 1 is a block diagram of an example operational scenario, according to some implementations of the present disclosure. In the example operational scenario, an environment 100 contains an autonomous platform 110 and a number of objects, including first actor 120, second actor 130, and third actor 140. In the example operational scenario, the autonomous platform 110 can move through the environment 100 and interact with the object(s) that are located within the environment 100 (e.g., first actor 120, second actor 130, third actor 140, etc.). The autonomous platform 110 can optionally be configured to communicate with remote system(s) 160 through network(s) 170.

The environment 100 may be or include an indoor environment (e.g., within one or more facilities, etc.) or an outdoor environment. An indoor environment, for example, may be an environment enclosed by a structure such as a building (e.g., a service depot, maintenance location, manufacturing facility, etc.). An outdoor environment, for example, may be one or more areas in the outside world such as, for example, one or more rural areas (e.g., with one or more rural travel ways, etc.), one or more urban areas (e.g., with one or more city travel ways, highways, etc.), one or more suburban areas (e.g., with one or more suburban travel ways, etc.), or other outdoor environments.

The autonomous platform 110 may be any type of platform configured to operate within the environment 100. For example, the autonomous platform 110 may be a vehicle configured to autonomously perceive and operate within the environment 100. The vehicle may be a ground-based autonomous vehicle such as, for example, an autonomous car, truck, van, etc. The autonomous platform 110 may be an autonomous vehicle that can control, be connected to, or be otherwise associated with implements, attachments, and/or accessories for transporting people or cargo. This can include, for example, an autonomous tractor optionally coupled to a cargo trailer. Additionally, or alternatively, the autonomous platform 110 may be any other type of vehicle such as one or more aerial vehicles, water-based vehicles, space-based vehicles, other ground-based vehicles, etc.

The autonomous platform 110 may be configured to communicate with the remote system(s) 160. For instance, the remote system(s) 160 can communicate with the autonomous platform 110 for assistance (e.g., navigation assistance, situation response assistance, etc.), control (e.g., fleet management, remote operation, etc.), maintenance (e.g., updates, monitoring, etc.), or other local or remote tasks. In some implementations, the remote system(s) 160 can provide data indicating tasks that the autonomous platform 110 should perform. For example, as further described herein, the remote system(s) 160 can provide data indicating that the autonomous platform 110 is to perform a trip/service such as a user transportation trip/service, delivery trip/service (e.g., for cargo, freight, items), etc.

The autonomous platform 110 can communicate with the remote system(s) 160 using the network(s) 170. The network(s) 170 can facilitate the transmission of signals (e.g., electronic signals, etc.) or data (e.g., data from a computing device, etc.) and can include any combination of various wired (e.g., twisted pair cable, etc.) or wireless communication mechanisms (e.g., cellular, wireless, satellite, microwave, radio frequency, etc.) or any desired network topology (or topologies). For example, the network(s) 170 can include a local area network (e.g., intranet, etc.), a wide area network (e.g., the Internet, etc.), a wireless LAN network (e.g., through Wi-Fi, etc.), a cellular network, a SATCOM network, a VHF network, a HF network, a WiMAX based network, or any other suitable communications network (or combination thereof) for transmitting data to or from the autonomous platform 110.

As shown for example in FIG. 1, the environment 100 can include one or more objects. The object(s) may be objects not in motion or not predicted to move (“static objects”) or object(s) in motion or predicted to be in motion (“dynamic objects” or “actors”). In some implementations, the environment 100 can include any number of actor(s) such as, for example, one or more pedestrians, animals, vehicles, etc. The actor(s) can move within the environment according to one or more actor trajectories. For instance, the first actor 120 can move along any one of the first actor trajectories 122A-C, the second actor 130 can move along any one of the second actor trajectories 132, the third actor 140 can move along any one of the third actor trajectories 142, etc.

As further described herein, the autonomous platform 110 can utilize its autonomy system(s) to detect these actors (and their movement) and plan its motion to navigate through the environment 100 according to one or more platform trajectories 112A-C. The autonomous platform 110 can include onboard computing system(s) 180. The onboard computing system(s) 180 can include one or more processors and one or more memory devices. The one or more memory devices can store instructions executable by the one or more processors to cause the one or more processors to perform operations or functions associated with the autonomous platform 110, including implementing its autonomy system(s).

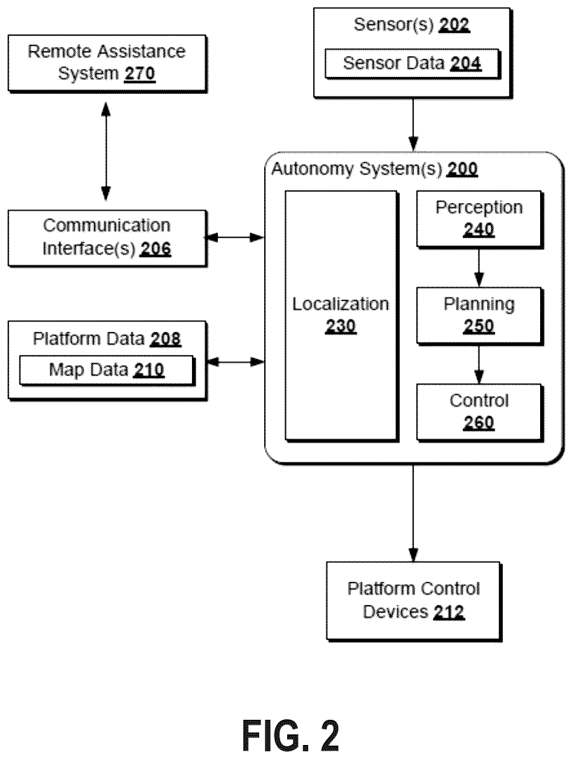

FIG. 2 is a block diagram of an example autonomy system 200 for an autonomous platform, according to some implementations of the present disclosure. In some implementations, the autonomy system 200 can be implemented by a computing system of the autonomous platform (e.g., the onboard computing system(s) 180 of the autonomous platform 110). The autonomy system 200 can operate to obtain inputs from sensor(s) 202 or other input devices. In some implementations, the autonomy system 200 can additionally obtain platform data 208 (e.g., map data 210) from local or remote storage. The autonomy system 200 can generate control outputs for controlling the autonomous platform (e.g., through platform control devices 212, etc.) based on sensor data 204, map data 210, or other data. The autonomy system 200 may include different subsystems for performing various autonomy operations. The subsystems may include a localization system 230, a perception system 240, a planning system 250, and a control system 260. The localization system 230 can determine the location of the autonomous platform within its environment; the perception system 240 can detect, classify, and track objects and actors in the environment; the planning system 250 can determine a trajectory for the autonomous platform; and the control system 260 can translate the trajectory into vehicle controls for controlling the autonomous platform. The autonomy system 200 can be implemented by one or more onboard computing system(s). The subsystems can include one or more processors and one or more memory devices. The one or more memory devices can store instructions executable by the one or more processors to cause the one or more processors to perform operations or functions associated with the subsystems. The computing resources of the autonomy system 200 can be shared among its subsystems, or a subsystem can have a set of dedicated computing resources.

In some implementations, the autonomy system 200 can be implemented for or by an autonomous vehicle (e.g., a ground-based autonomous vehicle). The autonomy system 200 can perform various processing techniques on inputs (e.g., the sensor data 204, the map data 210) to perceive and understand the vehicle's surrounding environment and generate an appropriate set of control outputs to implement a vehicle motion plan (e.g., including one or more trajectories) for traversing the vehicle's surrounding environment (e.g., environment 100 of FIG. 1, etc.). In some implementations, an autonomous vehicle implementing the autonomy system 200 can drive, navigate, operate, etc. with minimal or no interaction from a human operator (e.g., driver, pilot, etc.).

In some implementations, the autonomous platform can be configured to operate in a plurality of operating modes. For instance, the autonomous platform can be configured to operate in a fully autonomous (e.g., self-driving, etc.) operating mode in which the autonomous platform is controllable without user input (e.g., can drive and navigate with no input from a human operator present in the autonomous vehicle or remote from the autonomous vehicle, etc.). The autonomous platform can operate in a semi-autonomous operating mode in which the autonomous platform can operate with some input from a human operator present in the autonomous platform (or a human operator that is remote from the autonomous platform). In some implementations, the autonomous platform can enter into a manual operating mode in which the autonomous platform is fully controllable by a human operator (e.g., human driver, etc.) and can be prohibited or disabled (e.g., temporary, permanently, etc.) from performing autonomous navigation (e.g., autonomous driving, etc.). The autonomous platform can be configured to operate in other modes such as, for example, park or sleep modes (e.g., for use between tasks such as waiting to provide a trip/service, recharging, etc.). In some implementations, the autonomous platform can implement vehicle operating assistance technology (e.g., collision mitigation system, power assist steering, etc.), for example, to help assist the human operator of the autonomous platform (e.g., while in a manual mode, etc.).

The autonomy system 200 can be located onboard (e.g., on or within) an autonomous platform and can be configured to operate the autonomous platform in various environments. The environment may be a real-world environment or a simulated environment. In some implementations, one or more simulation computing devices can simulate one or more of: the sensors 202, the sensor data 204, communication interface(s) 206, the platform data 208, or the platform control devices 212 for simulating operation of the autonomy system 200.

In some implementations, the autonomy system 200 can communicate with one or more networks or other systems with the communication interface(s) 206. The communication interface(s) 206 can include any suitable components for interfacing with one or more network(s) (e.g., the network(s) 170 of FIG. 1, etc.), including, for example, transmitters, receivers, ports, controllers, antennas, or other suitable components that can help facilitate communication. In some implementations, the communication interface(s) 206 can include a plurality of components (e.g., antennas, transmitters, or receivers, etc.) that allow it to implement and utilize various communication techniques (e.g., multiple-input, multiple-output (MIMO) technology, etc.).

In some implementations, the autonomy system 200 can use the communication interface(s) 206 to communicate with one or more computing devices that are remote from the autonomous platform (e.g., the remote system(s) 160) over one or more network(s) (e.g., the network(s) 170). For instance, in some examples, one or more inputs, data, or functionalities of the autonomy system 200 can be supplemented or substituted by a remote system communicating over the communication interface(s) 206. For instance, in some implementations, the map data 210 can be downloaded over a network to a remote system using the communication interface(s) 206. In some examples, one or more of the localization system 230, the perception system 240, the planning system 250, or the control system 260 can be updated, influenced, nudged, communicated with, etc., by a remote system for assistance, maintenance, situational response override, management, etc.

The sensor(s) 202 can be located onboard the autonomous platform. In some implementations, the sensor(s) 202 can include one or more types of sensor(s). For instance, one or more sensors can include image capturing device(s) (e.g., visible spectrum cameras, infrared cameras, etc.). Additionally, or alternatively, the sensor(s) 202 can include one or more depth capturing device(s). For example, the sensor(s) 202 can include one or more Light Detection and Ranging (LIDAR) sensor(s) or Radio Detection and Ranging (RADAR) sensor(s). The sensor(s) 202 can be configured to generate point data descriptive of at least a portion of a three-hundred-and-sixty-degree view of the surrounding environment. The point data can be point cloud data (e.g., three-dimensional LIDAR point cloud data, RADAR point cloud data). In some implementations, one or more of the sensor(s) 202 for capturing depth information can be fixed to a rotational device in order to rotate the sensor(s) 202 about an axis. The sensor(s) 202 can be rotated about the axis while capturing data in interval sector packets descriptive of different portions of a three-hundred-and-sixty-degree view of a surrounding environment of the autonomous platform. In some implementations, one or more of the sensor(s) 202 for capturing depth information can be solid state.

The sensor(s) 202 can be configured to capture the sensor data 204 indicating or otherwise being associated with at least a portion of the environment of the autonomous platform. The sensor data 204 can include image data (e.g., 2D camera data, video data, etc.), RADAR data, LIDAR data (e.g., 3D point cloud data, etc.), audio data, or other types of data. In some implementations, the autonomy system 200 can obtain input from additional types of sensors, such as inertial measurement units (IMUs), altimeters, inclinometers, odometry devices, location or positioning devices (e.g., GPS, compass), wheel encoders, or other types of sensors. In some implementations, the autonomy system 200 can obtain sensor data 204 associated with particular component(s) or system(s) of an autonomous platform. This sensor data 204 can indicate, for example, wheel speed, component temperatures, steering angle, cargo or passenger status, etc. In some implementations, the autonomy system 200 can obtain sensor data 204 associated with ambient conditions, such as environmental or weather conditions. In some implementations, the sensor data 204 can include multi-modal sensor data. The multi-modal sensor data can be obtained by at least two different types of sensor(s) (e.g., of the sensors 202) and can indicate static object(s) or actor(s) within an environment of the autonomous platform. The multi-modal sensor data can include at least two types of sensor data (e.g., camera and LIDAR data). In some implementations, the autonomous platform can utilize the sensor data 204 for sensors that are remote from (e.g., offboard) the autonomous platform. This can include, for example, sensor data 204 captured by a different autonomous platform.

Some or all of the sensors 202 can have a sensing cycle. For example, a LIDAR sensor or sensors can scan a certain area during a particular sensing cycle to detect an object or an environment in the area. In some versions of those implementations, a given instance of the LIDAR data can include the LIDAR data from a given sensing cycle of a LIDAR sensor or sensors. For example, a given LIDAR data instance may correspond to a given sweep of the LIDAR sensor or sensors generated during the sensing cycle of the LIDAR sensor or sensors.

The LIDAR data generated during the sensing cycle of a LIDAR sensor or sensors can include, for example, a plurality of points reflected off of a surface of an object in an environment of the autonomous platform, and detected by at least one receiver component of the LIDAR sensor or sensors as data points. During a given sensing cycle, the LIDAR sensor or sensors can detect a plurality of data points in an area of the environment of the autonomous platform. One or more of the data points may also be captured in subsequent sensing cycles. Accordingly, the range and velocity for a point that is indicated by the LIDAR data sweep of the LIDAR sensor or sensors can be based on multiple sensing cycle events by referencing prior (and optionally subsequent) sensing cycle events. In some versions of those implementations, multiple (e.g., all) sensing cycles can have the same duration, the same field-of-view, and/or the same pattern of wave form distribution (through directing of the wave form during the sensing cycle). For example, multiple sweeps can have the same duration (e.g., 50 ms, 100 ms, 200 ms, 300 ms, or other durations) and the same field-of-view (e.g., 60°, 90°, 180°, 360°, or other fields-of-view). Also, in some implementations, sensors 202 other than LIDAR sensors may similarly have a sensing cycle similar to the example sensing cycles for LIDAR sensors described herein.

The autonomy system 200 can obtain the map data 210 associated with an environment in which the autonomous platform was, is, or will be located. The map data 210 can provide information about an environment or a geographic area. For example, the map data 210 can provide information regarding the identity and location of different travel ways (e.g., roadways, etc.), travel way segments (e.g., road segments, etc.), buildings, or other items or objects (e.g., lampposts, crosswalks, curbs, etc.); the location and directions of boundaries or boundary markings (e.g., the location and direction of traffic lanes, parking lanes, turning lanes, bicycle lanes, other lanes, etc.); traffic control data (e.g., the location and instructions of signage, traffic lights, other traffic control devices, etc.); obstruction information (e.g., temporary or permanent blockages, etc.); event data (e.g., road closures/traffic rule alterations due to parades, concerts, sporting events, etc.); nominal vehicle path data (e.g., indicating an ideal vehicle path such as along the center of a certain lane, etc.); or any other map data that provides information that assists an autonomous platform in understanding its surrounding environment and its relationship thereto. In some implementations, the map data 210 can include high-definition map information. Additionally, or alternatively, the map data 210 can include sparse map data (e.g., lane graphs, etc.). In some implementations, the sensor data 204 can be fused with or used to update the map data 210 in real-time.

The autonomy system 200 can include the localization system 230, which can provide an autonomous platform with an understanding of its location and orientation in an environment. In some examples, the localization system 230 can support one or more other subsystems of the autonomy system 200, such as by providing a unified local reference frame for performing, e.g., perception operations, planning operations, or control operations.

In some implementations, the localization system 230 can determine a current position of the autonomous platform. A current position can include a global position (e.g., respecting a georeferenced anchor, etc.) or relative position (e.g., respecting objects in the environment, etc.). The localization system 230 can generally include or interface with any device or circuitry for analyzing a position or change in position of an autonomous platform (e.g., autonomous ground-based vehicle, etc.). For example, the localization system 230 can determine position by using one or more of: inertial sensors (e.g., inertial measurement unit(s), etc.), a satellite positioning system, radio receivers, networking devices (e.g., based on IP address, etc.), triangulation or proximity to network access points or other network components (e.g., cellular towers, Wi-Fi access points, etc.), or other suitable techniques. The position of the autonomous platform can be used by various subsystems of the autonomy system 200 or provided to a remote computing system (e.g., using the communication interface(s) 206).

In some implementations, the localization system 230 can register relative positions of elements of a surrounding environment of an autonomous platform with recorded positions in the map data 210. For instance, the localization system 230 can process the sensor data 204 (e.g., LIDAR data, RADAR data, camera data, etc.) for aligning or otherwise registering to a map of the surrounding environment (e.g., from the map data 210) to understand the autonomous platform's position within that environment. Accordingly, in some implementations, the autonomous platform can identify its position within the surrounding environment (e.g., across six axes, etc.) based on a search over the map data 210. In some implementations, given an initial location, the localization system 230 can update the autonomous platform's location with incremental realignment based on recorded or estimated deviations from the initial location. In some implementations, a position can be registered directly within the map data 210.

In some implementations, the map data 210 can include a large volume of data subdivided into geographic tiles, such that a desired region of a map stored in the map data 210 can be reconstructed from one or more tiles. For instance, a plurality of tiles selected from the map data 210 can be stitched together by the autonomy system 200 based on a position obtained by the localization system 230 (e.g., a number of tiles selected in the vicinity of the position).

In some implementations, the localization system 230 can determine positions (e.g., relative or absolute) of one or more attachments or accessories for an autonomous platform. For instance, an autonomous platform can be associated with a cargo platform, and the localization system 230 can provide positions of one or more points on the cargo platform. For example, a cargo platform can include a trailer or other device towed or otherwise attached to or manipulated by an autonomous platform, and the localization system 230 can provide for data describing the position (e.g., absolute, relative, etc.) of the autonomous platform as well as the cargo platform. Such information can be obtained by the other autonomy systems to help operate the autonomous platform.

The autonomy system 200 can include the perception system 240, which can allow an autonomous platform to detect, classify, and track actors and other objects and in its environment. Environmental features or objects perceived within an environment can be those within the field of view of the sensor(s) 202 or predicted to be occluded from the sensor(s) 202. This can include object(s) not in motion or not predicted to move (static objects) or object(s) in motion or predicted to be in motion (dynamic objects/actors).

The perception system 240 can determine one or more states (e.g., current or past state(s), etc.) of one or more objects that are within a surrounding environment of an autonomous platform. For example, state(s) can describe (e.g., for a given time, time period, etc.) an estimate of an object's current or past location (also referred to as position); current or past speed/velocity; current or past acceleration; current or past heading; current or past orientation; size/footprint (e.g., as represented by a bounding shape, object highlighting, etc.); classification (e.g., pedestrian class vs. vehicle class vs. bicycle class, etc.); the uncertainties associated therewith; or other state information. In some implementations, the perception system 240 can determine the state(s) using one or more algorithms or machine-learned models configured to identify/classify objects based on inputs from the sensor(s) 202. The perception system 240 can use different modalities of the sensor data 204 to generate a representation of the environment to be processed by the one or more algorithms or machine-learned model. In some implementations, state(s) for one or more identified or unidentified objects can be maintained and updated over time as the autonomous platform continues to perceive or interact with the objects (e.g., maneuver with or around, yield to, etc.). In this manner, the perception system 240 can provide an understanding about a current state of an environment (e.g., including the objects therein, etc.) informed by a record of prior states of the environment (e.g., including movement histories for the objects therein). Such information can be helpful as the autonomous platform plans its motion through the environment.

The autonomy system 200 can include the planning system 250, which can be configured to determine how the autonomous platform is to interact with and move within its environment. The planning system 250 can determine one or more motion plans for an autonomous platform. A motion plan can include one or more trajectories (e.g., motion trajectories) that indicate a path for an autonomous platform to follow. A trajectory can be of a certain length or time range. The length or time range can be defined by the computational planning horizon of the planning system 250. A motion trajectory can be defined by one or more waypoints (with associated coordinates). The waypoint(s) can be future location(s) for the autonomous platform. The motion plans can be continuously generated, updated, and considered by the planning system 250.

The planning system 250 can determine a strategy for the autonomous platform. A strategy may be a set of discrete decisions (e.g., yield to actor, reverse yield to actor, merge, lane change) that the autonomous platform makes. The strategy may be selected from a plurality of potential strategies. The selected strategy may be a lowest cost strategy as determined by one or more cost functions. The cost functions may, for example, evaluate the probability of a collision with another actor or object.

The planning system 250 can determine a desired trajectory for executing a strategy. For instance, the planning system 250 can obtain one or more trajectories for executing one or more strategies. The planning system 250 can evaluate trajectories or strategies (e.g., with scores, costs, rewards, constraints, etc.) and rank them. For instance, the planning system 250 can use forecasting output(s) that indicate interactions (e.g., proximity, intersections, etc.) between trajectories for the autonomous platform and one or more objects to inform the evaluation of candidate trajectories or strategies for the autonomous platform. In some implementations, the planning system 250 can utilize static cost(s) to evaluate trajectories for the autonomous platform (e.g., “avoid lane boundaries,” “minimize jerk,” etc.). Additionally, or alternatively, the planning system 250 can utilize dynamic cost(s) to evaluate the trajectories or strategies for the autonomous platform based on forecasted outcomes for the current operational scenario (e.g., forecasted trajectories or strategies leading to interactions between actors, forecasted trajectories or strategies leading to interactions between actors and the autonomous platform, etc.). The planning system 250 can rank trajectories based on one or more static costs, one or more dynamic costs, or a combination thereof. The planning system 250 can select a motion plan (and a corresponding trajectory) based on a ranking of a plurality of candidate trajectories. In some implementations, the planning system 250 can select a highest ranked candidate, or a highest ranked feasible candidate.

The planning system 250 can then validate the selected trajectory against one or more constraints before the trajectory is executed by the autonomous platform.

To help with its motion planning decisions, the planning system 250 can be configured to perform a forecasting function. The planning system 250 can forecast future state(s) of the environment. This can include forecasting the future state(s) of other actors in the environment. In some implementations, the planning system 250 can forecast future state(s) based on current or past state(s) (e.g., as developed or maintained by the perception system 240). In some implementations, future state(s) can be or include forecasted trajectories (e.g., positions over time) of the objects in the environment, such as other actors. In some implementations, one or more of the future state(s) can include one or more probabilities associated therewith (e.g., marginal probabilities, conditional probabilities). For example, the one or more probabilities can include one or more probabilities conditioned on the strategy or trajectory options available to the autonomous platform. Additionally, or alternatively, the probabilities can include probabilities conditioned on trajectory options available to one or more other actors.

In some implementations, the planning system 250 can perform interactive forecasting. The planning system 250 can determine a motion plan for an autonomous platform with an understanding of how forecasted future states of the environment can be affected by execution of one or more candidate motion plans. By way of example, with reference again to FIG. 1, the autonomous platform 110 can determine candidate motion plans corresponding to a set of platform trajectories 112A-C that respectively correspond to the first actor trajectories 122A-C for the first actor 120, trajectories 132 for the second actor 130, and trajectories 142 for the third actor 140 (e.g., with respective trajectory correspondence indicated with matching line styles). For instance, the autonomous platform 110 (e.g., using its autonomy system 200) can forecast that a platform trajectory 112A to more quickly move the autonomous platform 110 into the area in front of the first actor 120 is likely associated with the first actor 120 decreasing forward speed and yielding more quickly to the autonomous platform 110 in accordance with first actor trajectory 122A. Additionally, or alternatively, the autonomous platform 110 can forecast that a platform trajectory 112B to gently move the autonomous platform 110 into the area in front of the first actor 120 is likely associated with the first actor 120 slightly decreasing speed and yielding slowly to the autonomous platform 110 in accordance with first actor trajectory 122B. Additionally, or alternatively, the autonomous platform 110 can forecast that a platform trajectory 112C to remain in a parallel alignment with the first actor 120 is likely associated with the first actor 120 not yielding any distance to the autonomous platform 110 in accordance with first actor trajectory 122C. Based on comparison of the forecasted scenarios to a set of desired outcomes (e.g., by scoring scenarios based on a cost or reward), the planning system 250 can select a motion plan (and its associated trajectory) in view of the autonomous platform's interaction with the environment 100. In this manner, for example, the autonomous platform 110 can interleave its forecasting and motion planning functionality.

To implement selected motion plan(s), the autonomy system 200 can include a control system 260 (e.g., a vehicle control system). Generally, the control system 260 can provide an interface between the autonomy system 200 and the platform control devices 212 for implementing the strategies and motion plan(s) generated by the planning system 250. For instance, the control system 260 can implement the selected motion plan/trajectory to control the autonomous platform's motion through its environment by following the selected trajectory (e.g., the waypoints included therein). The control system 260 can, for example, translate a motion plan into instructions for the appropriate platform control devices 212 (e.g., acceleration control, brake control, steering control, etc.). By way of example, the control system 260 can translate a selected motion plan into instructions to adjust a steering component (e.g., a steering angle) by a certain number of degrees, apply a certain magnitude of braking force, increase/decrease speed, etc. In some implementations, the control system 260 can communicate with the platform control devices 212 through communication channels including, for example, one or more data buses (e.g., controller area network (CAN), etc.), onboard diagnostics connectors (e.g., OBD-II, etc.), or a combination of wired or wireless communication links. The platform control devices 212 can send or obtain data, messages, signals, etc. to or from the autonomy system 200 (or vice versa) through the communication channel(s).

The autonomy system 200 can receive, through communication interface(s) 206, assistive signal(s) from remote assistance system 270. Remote assistance system 270 can communicate with the autonomy system 200 over a network (e.g., as a remote system 160 over network 170). In some implementations, the autonomy system 200 can initiate a communication session with the remote assistance system 270. For example, the autonomy system 200 can initiate a session based on or in response to a trigger. In some implementations, the trigger may be an alert, an error signal, a map feature, a request, a location, a traffic condition, a road condition, etc.

After initiating the session, the autonomy system 200 can provide context data to the remote assistance system 270. The context data may include sensor data 204 and state data of the autonomous platform. For example, the context data may include a live camera feed from a camera of the autonomous platform and the autonomous platform's current speed. An operator (e.g., human operator) of the remote assistance system 270 can use the context data to select assistive signals. The assistive signal(s) can provide values or adjustments for various operational parameters or characteristics for the autonomy system 200. For instance, the assistive signal(s) can include waypoints (e.g., a path around an obstacle, lane change, etc.), velocity or acceleration profiles (e.g., speed limits, etc.), relative motion instructions (e.g., convoy formation, etc.), operational characteristics (e.g., use of auxiliary systems, reduced energy processing modes, etc.), or other signals to assist the autonomy system 200.

The autonomy system 200 can use the assistive signal(s) for input into one or more autonomy subsystems for performing autonomy functions. For instance, the planning system 250 can receive the assistive signal(s) as an input for generating a motion plan. For example, assistive signal(s) can include constraints for generating a motion plan. Additionally, or alternatively, assistive signal(s) can include cost or reward adjustments for influencing motion planning by the planning system 250. Additionally, or alternatively, assistive signal(s) can be considered by the autonomy system 200 as suggestive inputs for consideration in addition to other received data (e.g., sensor inputs, etc.).

The autonomy system 200 may be platform agnostic, and the control system 260 can provide control instructions to platform control devices 212 for a variety of different platforms for autonomous movement (e.g., a plurality of different autonomous platforms fitted with autonomous control systems). This can include a variety of different types of autonomous vehicles (e.g., sedans, vans, SUVs, trucks, electric vehicles, combustion power vehicles, etc.) from a variety of different manufacturers/developers that operate in various different environments and, in some implementations, perform one or more vehicle services.

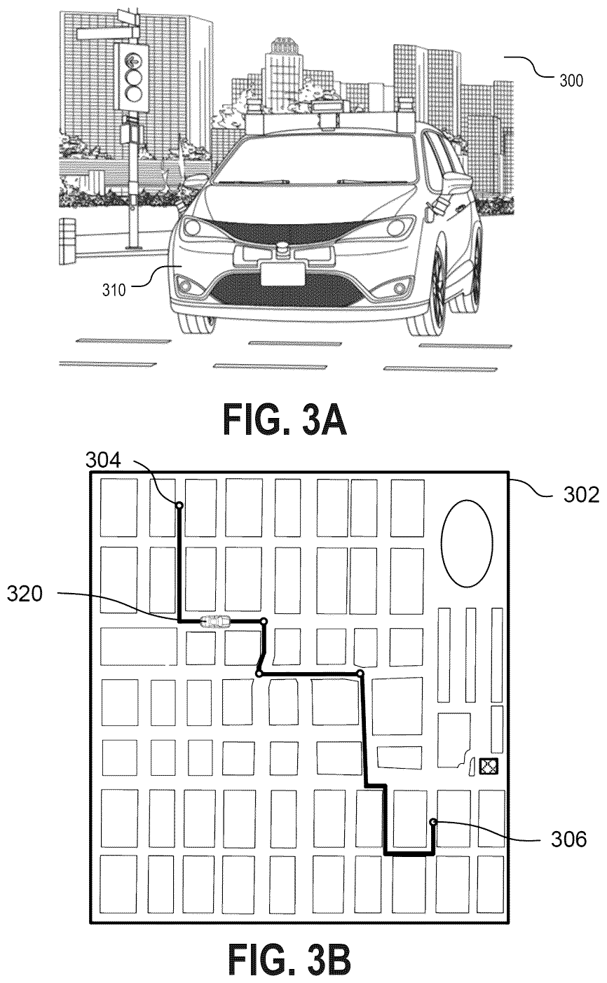

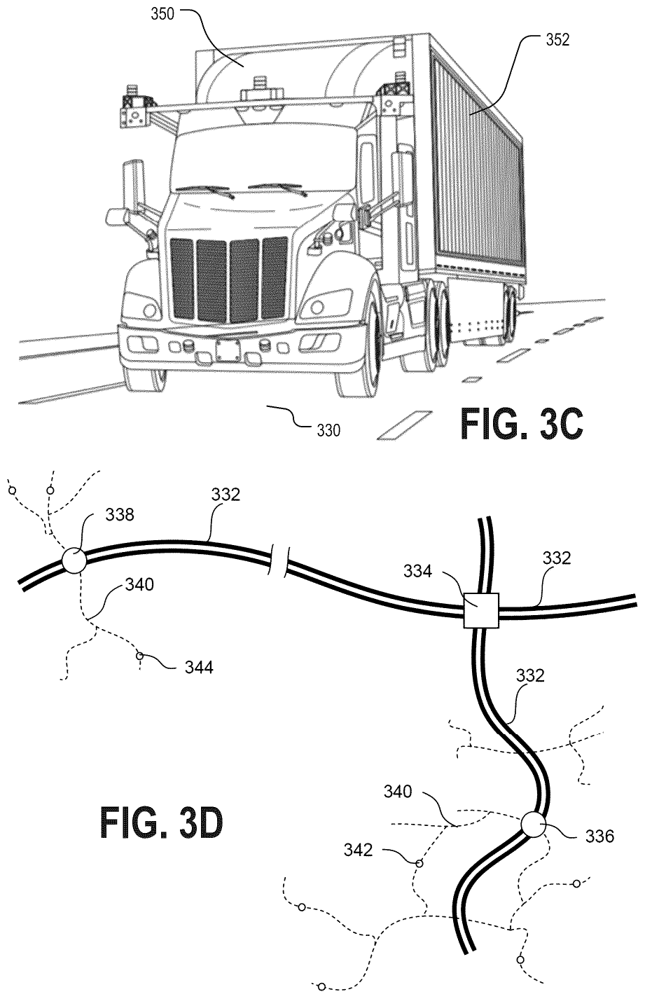

For example, with reference to FIG. 3A, an operational environment can include a dense environment 300. An autonomous platform can include an autonomous vehicle 310 controlled by the autonomy system 200. In some implementations, the autonomous vehicle 310 can be configured for maneuverability in a dense environment, such as with a configured wheelbase or other specifications. In some implementations, the autonomous vehicle 310 can be configured for transporting cargo or passengers. In some implementations, the autonomous vehicle 310 can be configured to transport numerous passengers (e.g., a passenger van, a shuttle, a bus, etc.). In some implementations, the autonomous vehicle 310 can be configured to transport cargo, such as large quantities of cargo (e.g., a truck, a box van, a step van, etc.) or smaller cargo (e.g., food, personal packages, etc.).

With reference to FIG. 3B, a selected overhead view 302 of the dense environment 300 is shown overlaid with an example trip/service between a first location 304 and a second location 306. The example trip/service can be assigned, for example, to an autonomous vehicle 320 by a remote computing system. The autonomous vehicle 320 can be, for example, the same type of vehicle as autonomous vehicle 310. The example trip/service can include transporting passengers or cargo between the first location 304 and the second location 306. In some implementations, the example trip/service can include travel to or through one or more intermediate locations, such as to onload or offload passengers or cargo. In some implementations, the example trip/service can be prescheduled (e.g., for regular traversal, such as on a transportation schedule). In some implementations, the example trip/service can be on-demand (e.g., as requested by or for performing a taxi, rideshare, ride hailing, courier, delivery service, etc.).

With reference to FIG. 3C, in another example, an operational environment can include an open travel way environment 330. An autonomous platform can include an autonomous vehicle 350 controlled by the autonomy system 200. This can include an autonomous tractor for an autonomous truck. In some implementations, the autonomous vehicle 350 can be configured for high payload transport (e.g., transporting freight or other cargo or passengers in quantity), such as for long distance, high payload transport. For instance, the autonomous vehicle 350 can include one or more cargo platform attachments such as a trailer 352. Although depicted as a towed attachment in FIG. 3C, in some implementations one or more cargo platforms can be integrated into (e.g., attached to the chassis of, etc.) the autonomous vehicle 350 (e.g., as in a box van, step van, etc.).

With reference to FIG. 3D, a selected overhead view of open travel way environment 330 is shown, including travel ways 332, an interchange 334, transfer hubs 336 and 338, access travel ways 340, and locations 342 and 344. In some implementations, an autonomous vehicle (e.g., the autonomous vehicle 310 or the autonomous vehicle 350) can be assigned an example trip/service to traverse the one or more travel ways 332 (optionally connected by the interchange 334) to transport cargo between the transfer hub 336 and the transfer hub 338. For instance, in some implementations, the example trip/service includes a cargo delivery/transport service, such as a freight delivery/transport service. The example trip/service can be assigned by a remote computing system. In some implementations, the transfer hub 336 can be an origin point for cargo (e.g., a depot, a warehouse, a facility, etc.) and the transfer hub 338 can be a destination point for cargo (e.g., a retailer, etc.). However, in some implementations, the transfer hub 336 can be an intermediate point along a cargo item's ultimate journey between its respective origin and its respective destination. For instance, a cargo item's origin can be situated along the access travel ways 340 at the location 342. The cargo item can accordingly be transported to the transfer hub 336 (e.g., by a human-driven vehicle, by the autonomous vehicle 310, etc.) for staging. At the transfer hub 336, various cargo items can be grouped or staged for longer distance transport over the travel ways 332.

In some implementations of an example trip/service, a group of staged cargo items can be loaded onto an autonomous vehicle (e.g., the autonomous vehicle 350) for transport to one or more other transfer hubs, such as the transfer hub 338. For instance, although not depicted, it is to be understood that the open travel way environment 330 can include more transfer hubs than the transfer hubs 336 and 338 and can include more travel ways 332 interconnected by more interchanges 334. A simplified map is presented here for purposes of clarity only. In some implementations, one or more cargo items transported to the transfer hub 338 can be distributed to one or more local destinations (e.g., by a human-driven vehicle, by the autonomous vehicle 310, etc.), such as along the access travel ways 340 to the location 344. In some implementations, the example trip/service can be prescheduled (e.g., for regular traversal, such as on a transportation schedule). In some implementations, the example trip/service can be on-demand (e.g., as requested by or for performing a chartered passenger transport or freight delivery service).

A sensor or sensors on an autonomous vehicle or other autonomous platform may generate sensor data conveying different levels of information depending on visibility levels. Different visibility levels may occur, for example, due to the presence of environmental factors such as precipitation, smoke, fog, and/or the like. For example, sensor data captured during a heavy rainstorm may convey less useful information to an autonomy system than sensor data captured during clear conditions.

The amount of useful information provided by sensor data to the autonomy system of an autonomous vehicle or other autonomous platform may be referred to as sensor support. For example, sensor data having a high level of sensor support may include information allowing the autonomy system (e.g., the perception system thereof) to detect actors and other objects at a given range. As sensor support degrades, the range at which the autonomy system will be able to detect actors and other objects may decline.

In some examples, it is desirable for the autonomy system to operate considering current sensor support. For example, when accessing sensor data having low sensor support, the perception system may be less likely to identify actors and other objects until they are closer to the autonomous vehicle than would be the case in clear conditions. As a result, the planning system may be modified to reflect the corresponding lower level of certainty as to the existence of actors and/or other objects at longer ranges. For example, the planning system may determine a more conservative motion plan for the autonomous vehicle when the sensor support level is lower. A more conservative motion plan may, for example, include a lower speed for the autonomous vehicle, an increase in following distance for the autonomous vehicle, and/or the like.

In some examples, an autonomous vehicle may have a human operator on board. The human operator may monitor the operation of the autonomy system. If the human operator observes that sensor support has degraded, for example, due to environmental factors, the human operator may provide appropriate instructions to the autonomy system such as, instructing the autonomy system to reduce a speed of the autonomous vehicle, disengaging the autonomy system, assuming control of the vehicle, and/or the like. The human operator may determine that sensor support has degraded by observing environmental factors present in the vehicle's environment and/or by observing the manner in which the autonomy system is controlling the autonomous vehicle.

In some examples, the autonomy system is arranged to detect changes sensor support, for example, due to changing environmental factors. The autonomy system may be arranged to automatically modify operation of the autonomous vehicle in response to changes in sensor support. In some examples, this may facilitate a reduction in the role of the human operator and/or the elimination of the human operator from the autonomous vehicle.

In some examples, the autonomy system may be programmed to execute a machine-learned model to determine a sensor support. The machine-learned model may receive input including sensor data generated by at least one sensor corresponding to the autonomous vehicle. As output, the machine-learned model may generate an indication of sensor support provided by the sensor data. For example, the sensor support data may characterize the sensor data to indicate a distance at which a reference object would meet a detectability threshold (e.g., if the reference object were depicted by the sensor data). It will be appreciated that the machine-learned model may be trained to characterize the distance at which the reference object would meet the detectability threshold regardless of whether an example of the reference object is depicted by the input sensor data.

The indication of sensor support generated by the machine-learned model may be provided to the planning system. In this way, the planning system may generate strategies and/or other motion plans for the autonomous vehicle based on the quality of the sensor data being generated. In this way, the autonomous vehicle may adjust to changes in environmental conditions and corresponding changes to the sensor support provided by sensor data.

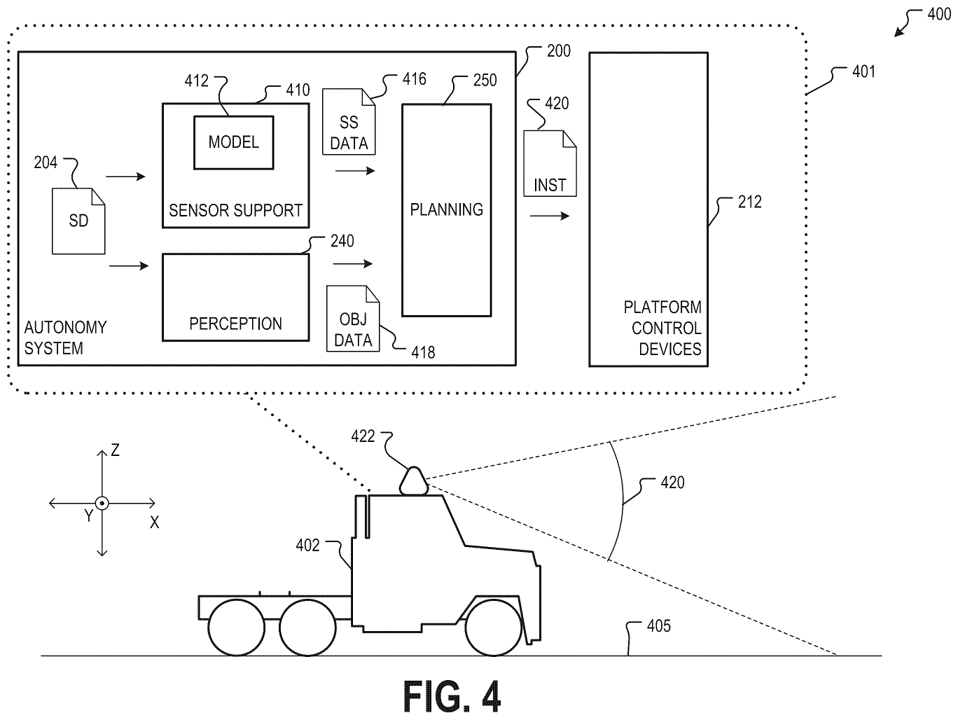

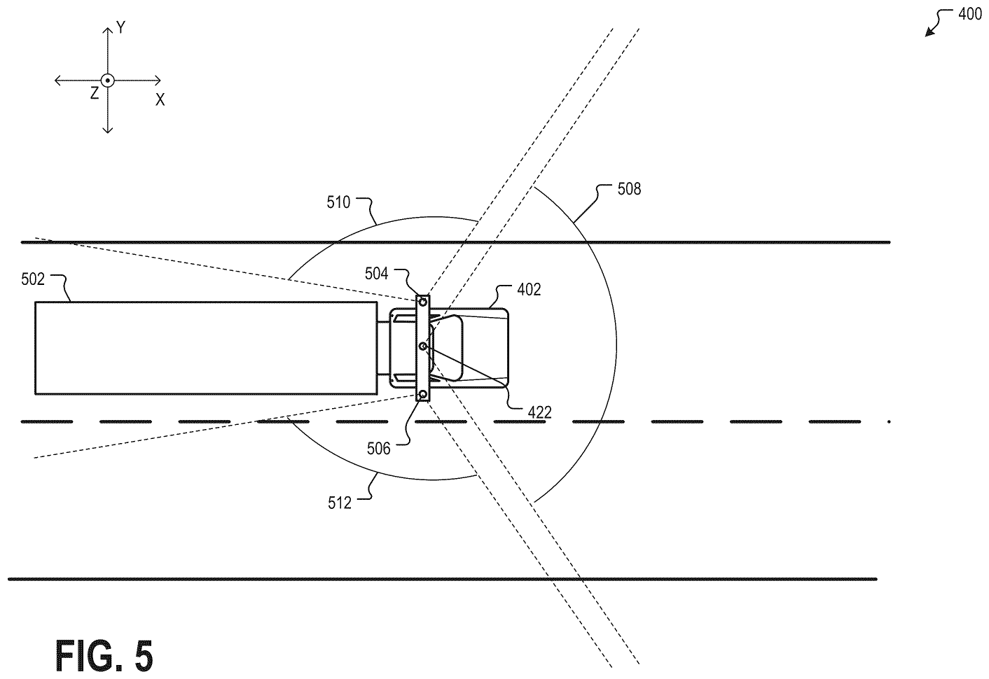

FIG. 4 is a diagram showing one example of an environment 400 including an autonomous vehicle 402 traveling on a travel way 405. In this example, the autonomous vehicle 402 is a tractor. In some examples, although not shown in FIG. 4, the autonomous vehicle 402 may pull a trailer 502 (for example, as in FIG. 5).

The autonomous vehicle 402 comprises a sensor 422. A vertical field-of-view for 20 of the sensor 422 is depicted. It will be appreciated, however, that the sensor 422 may have any suitable vertical field-of-view that may be fixed and/or steerable. The sensor 422 may be or include any suitable sensor or sensor type such as, for example, a LIDAR sensor, a RADAR sensor, an optical image capturing device, or the like. In some examples the sensor 422 may be arranged in a manner similar to that described with respect to the sensors 202 of FIG. 2. For example, the sensor 422 may generate sensor data 204, also described with respect to FIG. 2. Also, although a single sensor 422 is shown in FIG. 4, it will be appreciated that the autonomous vehicle 402 may include multiple sensors, for example, as illustrated in more detail in FIG. 5.

FIG. 4 also includes a breakout window 401 showing an example of the autonomy system 200 that may be used with the autonomous vehicle 402. The example of the autonomy system 200 shown in FIG. 4 includes a sensor support system 410. The sensor support system 410 is configured to receive sensor data 204 and generate sensor support data 416 describing a level of sensor support indicated by the sensor data 204. The sensor support system 410 may provide the sensor support data 416 to the planning system 250. As described herein, the planning system 250 may also receive, from the perception system 240, object data 418 describing actors and/or other objects present in the environment 400 and detected in the sensor data 204.

The sensor support data 416 may provide the planning system 250 with context describing potential limitations of the object data 418, including potential omissions from the object data 418. For example, when the sensor support data 416 indicates a higher-level of sensor support, the planning system 250 may generate trajectories, motion plans, and/or strategies with a higher-level of confidence that the object data 418 describes all objects within a given range of the autonomous vehicle 402. When the sensor support data 416 indicates a lower level of sensor support, the planning system may generate trajectories, motion plans, and/or strategies with a lower level of confidence that the object data 418 describes all objects within the given range of the autonomous vehicle 402. For example, the planning system 250 may reduce a speed of the autonomous vehicle 402 or otherwise modify the operation of the autonomous vehicle to account for the possible presence of additional objects not described by the object data 418. The planning system 250, as described herein, may generate a trajectory, motion plan, and/or strategy and convert to instructions 420. The instructions 420 may be provided to one or more platform control devices 212 to affect the operation of the autonomous vehicle 402.

In some examples, the sensor support system 410 utilizes a machine-learned model 412 to determine, from the sensor data 204, a level of sensor support, indicated by sensor support data 416. The machine-learned model 412 may be trained to receive some or all of the sensor data 204 as input and to provide an output indicating a level of sensor support associated with the sensor data 204. The machine-learned model 412 may also be referred to as a machine-learned or machine learning model. The machine-learned model 412 may be or include any suitable type of computerized model including, for example, a classification model, a regression model, a clustering model, and/or the like. For example, a regression model may be used in some implementations in which the output of the model is an indication of the distance at which the reference object would meet a detectability threshold. Also, in some examples, the classification model may be used in examples in which training data is labeled with labels describing environmental conditions depicted by the logged sensor data. In some examples, the use of a classification model may reduce noise associated with the model relative to implementations utilizing a regression model.

In some examples, the machine-learned model 412 is trained to generate an intermediate output indicating sensor support. Based on the intermediate output, the machine-learned model 412 generates a final output indicating a visibility condition being experienced by the sensors of the autonomous vehicle 402. For example, the machine-learned model 412 may be structured with different layers. The output at an intermediate layer may indicate a sensor support such as, for example, a distance at which the reference object meets the detectability threshold, a sensor support quantity for the reference object over a set of two or more distances, and/or the like. The output of the intermediate layer may be provided to an output layer that generates the indication of the visibility condition. In some examples, the visibility conditions may be selected from a range of visibility conditions. In some examples, the range of visibility conditions may have 2, 3, 4, or more conditions. The output layer may provide a visibility condition selected from the range of visibility conditions.

In some examples, the machine-learned model 412 is trained using logged sensor data including sensor data captured by one or more reference vehicles during previously-executed trips. The reference vehicle or vehicles may include any vehicle or vehicles that execute trips and capture sensor data. For example, the reference vehicle may be or include the autonomous vehicle 402, other autonomous vehicles, non-autonomous vehicles comprising one or more sensors, and/or the like. The logged sensor data may comprise a plurality of instances. Each instance of logged sensor data may include sensor data captured by a reference vehicle at a given time or range of times. In some examples, an instance of logged sensor data may comprise sensor data captured by a reference vehicle during a sensing cycle of one or more sensors at the reference vehicle.

Logged sensor data may be labeled for use as training data. In some examples, logged sensor data may be labeled by a human user, or automatically. Label data for an instance of logged sensor data may include a visibility classification describing environmental conditions depicted by the logged sensor data. The example labels describing environmental conditions depicted by logged sensor data may include, a visibility condition selected from the range of visibility conditions such as, for example, nominal, degraded, severely degraded, and/or the like. In some examples, a nominal visibility condition may correspond to a clear, sunny day. A degraded visibility condition may correspond to moderate precipitation and/or moderately dense fog. A severely degraded visibility condition may correspond to heavy precipitation and/or heavy, dense fog.

For example, a nominal visibility condition may correspond to a first performance level of one or more sensors on the vehicle or other actors. For example, the first performance level can correspond to a first range threshold (e.g., 200 meters). For example, a degraded visibility condition may correspond to a second performance level of one or more sensors on the vehicle or other actors. For example, the second performance level can correspond to a second range threshold less than the first range threshold (e.g., 100 meters). For example, a severely degraded visibility condition may correspond to a third performance level of one or more sensors on the vehicle or other actors. For example, the third performance level can correspond to a third range threshold less than that the second range threshold (e.g., 20 m). For example, a performance level for one or more sensors can include a determination that sensor returns from a predetermined size or shape of object (e.g., tire fragment) are or can be received a corresponding one of the first, second, or third range thresholds. The performance level can differ according to range threshold (e.g., percent of returns over a given time period). For example, a performance level can include a determination that perception-based tracking of an object having a predetermined size or shape of object (e.g., tire fragment) are or can be maintained at a corresponding one of the first, second, or third range thresholds. The performance level can differ according to range threshold (e.g., percent of frames in which perception-based tracking is achieved for the object over a given time period).

In some examples, logged sensor data used as training data may be labeled to indicate one or more reference objects that are depicted by the logged sensor data. Such labels may include a two-dimensional bounding box indicating a position in the logged sensor data where the reference object is depicted. In some examples, labels may include a four-dimensional indication of the reference object across multiple logged sensor data instances, for example, captured by a reference vehicle in consecutive sensing cycles. The logged sensor data may also be labeled to indicate a range to the reference object or objects.

The instances of logged sensor data may also be labeled to reflect a sensor support quantity for each depicted reference object. The sensor support quantity may describe a degree to which the reference object is represented in the logged sensor data. Consider an example in which the logged sensor data comprises data captured using a LIDAR sensor. The sensor support quantity may include a number of returned points corresponding to the reference object. Consider another example in which the logged sensor data comprises data captured using an image sensor. The sensor support quantity may include an output of a second machine-learned model used to detect the object and/or a quantitative result of applying a detection mask to the portion of the logged sensor data depicting the reference object. In some examples, the sensor support quantity for reference objects depicted by logged sensor data may be normalized by surface area or apparent surface area. For example, the sensor support quantity may be expressed per unit surface area or apparent surface area. The apparent surface area of a reference object may describe the surface area of the object visible to the sensor or sensors associated with the autonomous vehicle. For example, the apparent surface area of the reference object may be an area of the reference object projected into the perspective of the sensor or sensors associated with the autonomous vehicle. This may normalize the logged sensor data across instances depicting reference objects having different exposed service areas relative to the sensor or sensors.

Training data, including logged sensor data and associated labels, may be used to train the machine-learned model 412. In some examples, the machine-learned model 412 is trained to generate an output describing current environmental conditions, which provide a qualitative indication of sensor support. In some examples, the machine-learned model 412 is trained based on a reference object. A reference object is an object that is depicted in all or some of the logged sensor data that is used as training data for the machine-learned model 412. Various different types of reference objects may be used including, for example, street signs, traffic signals, and/or the like. In some examples, the reference object may be tire retreads or other tire debris. For example, tire debris may be commonly depicted in logged sensor data. Also, for example, tire debris may have a relatively low reflectivity, making it difficult to detect the presence of tire debris in sensor data.

In some examples, the machine-learned model 412 is trained using training data that is labeled to indicate both current environmental conditions depicted by the logged sensor data and information about a depicted reference object. For example, as described herein, an intermediate layer of the machine-learned model 412 may provide an output indicating a level of sensor support, for example, based on depicted reference objects while an output layer may generate an output indicating a visibility classification (e.g., nominal, degraded, severely degraded, and/or the like). In some examples, such a machine-learned model 412 may be trained using labels indicating sensor support based on a depicted reference object and labels indicating the current environmental conditions.

The machine-learned model 412 may be trained to receive sensor data 204 as input and generate an output indicating a sensor support quantity associated with an example of the reference object, were the reference object depicted in the sensor data 204. In some examples, the output of the machine-learned model 412 is expressed over a range or set of ranges of distance. For example, the output of the machine-learned model 412 may provide a sensor support quantity for a reference object having a given exposed surface area across multiple distances. Consider the example in which the sensor data 204 is captured, in whole or in part, by a LIDAR sensor. The output of the machine-learned model 412 may indicate a number of returned lidar points that would be expected in the sensor data 204 if an example of the reference object were present at a first distance, at a second distance, and so on. The machine-learned model 412 may be trained to provide the sensor support quantity regardless of whether the reference object is actually depicted in the sensor data 204 used as input to the machine-learned model 412.

The sensor support system 410 may provide the output of the machine-learned model 412 to the planning system 250 as sensor support data 416. In some examples, the sensor support system 410 may modify the output of the machine-learned model 412 to generate the sensor support data 416 provided to the planning system 250. Consider again the example in which the machine-learned model 412 provides an output indicating a sensor support quantity for an instance of the reference object over a number of different ranges. The sensor support system 410 may be configured to select the range at which the corresponding sensor support quantity exceeds a detectability threshold.

The detectability threshold describes a level of sensor support at which the perception system 240 will correctly detect the presence of the reference object. In examples utilizing a LIDAR or RADAR sensor, the detectability threshold may be expressed as a number of returned points and/or a number of returned points per unit surface area. In examples utilizing sensor data 204 captured using a visual camera, the detectability threshold may be expressed based on the technique that would be used (e.g., by the perception system 240) to identify the reference object. Consider an example in which the perception system 240 applies a classical object detection mask operation across sensor data 204 to identify objects including the reference object. The detectability threshold for sensor data 204, then, may be a quantitative result of the object detection mask operation indicating the presence of the reference object. Consider another example in which the perception system 240 applies a machine-learned model that is trained to identify instances of the reference object (e.g., different than the machine-learned model 412). The detectability threshold for sensor data 204 may be a result of the machine-learned model indicating the presence of the reference object.

As described herein, the machine-learned model 412 may be trained using logged sensor data that depicts examples of a reference object. It will be appreciated, however, that the machine-learned model 412 may be executed based on sensor data 204 that does not depict an example of the reference object. Accordingly, the machine-learned model 412 may provide an output indicating a sensor support quantity for the reference object at one or more distances if the reference object were depicted in the sensor data 204 even if a particular instance of the sensor data 204 does not depict an example of the reference object.

FIG. 5 is a diagram showing another example of the environment 400 of FIG. 4 viewing the autonomous vehicle 402 from a top-down view parallel to the Z axis. The top-down view shown in FIG. 5 illustrates an example azimuth field-of-view 508 for the sensor 422. FIG. 5 also illustrates other example features. For example, in the depiction of FIG. 5, the autonomous vehicle 402 is a tractor that is pulling a trailer 502. FIG. 5 also shows additional sensors 504, 506. The sensor 504 has an azimuth field-of-view 510. The sensor 506 has an azimuth field-of-view 512. It will be appreciated that, in some examples, the sensors 504, 506 may have fixed field-of-view or may be steerable, for example, in at least one of the vertical direction or the azimuth direction, but is not limited thereto.

In some examples, the sensor support system 410 may be configured to generate sensor support data 416 describing each of the sensors 422, 504, 506. For example, visibility conditions may not be the same for all sensors 422, 504, 506 and/or in all directions around the autonomous vehicle 402. Different sensors may have different levels of sensor support in the same conditions.

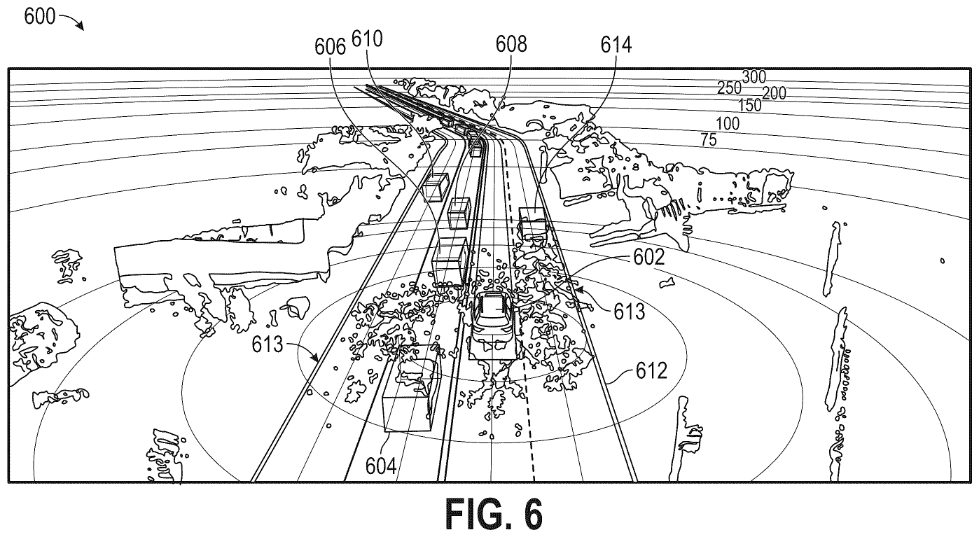

FIG. 6 is a representation of an environment 600 comprising an autonomous vehicle 602 traveling on a roadway 612 in the presence of environmental factors that limit sensor support. The environment 600 also includes actors 604, 606, 608, 610, 614. In this example, the actors 604, 606, 608, 610, 614 are at least partially obscured to sensors of the autonomous vehicle 602 because of the presence of spray 613 from precipitation. Accordingly, the sensor support provided by sensors of the autonomous vehicle 602 may be degraded relative to the sensor support provided in clear conditions.

Also, as illustrated in FIG. 6, the spray 613 is not uniform around the autonomous vehicle 602. Accordingly, different sensors having different fields in view around the autonomous vehicle 602 may have different levels of sensor support. In some examples, as described with respect to FIGS. 4 and 5, the sensor support system 410 may generate sensor support data 416 indicating different levels of sensor support for different sensors and/or for different positions around an autonomous vehicle. The planning system 250 may modify its operation based on the indicated sensor support in different directions.

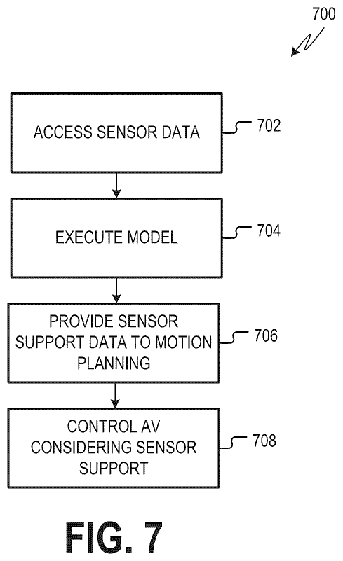

FIG. 7 is a flowchart showing one example of a process flow 700 that may be executed at the autonomous vehicle 402 (e.g. by the autonomy system 200 thereof) to operate the autonomous vehicle 404 considering sensor support data 416. At operation 702, the autonomy system 200 (e.g. the sensor support system 410 thereof) accesses sensor data 204. The sensor data 204 that is accessed may represent data generated over one sensing cycle. The sensor data 204 may include data generated by a single sensor and/or data generated by multiple sensors of different types and/or having different fields-of-view.

At operation 704, the autonomy system 200 (e.g., the sensor support system 410 thereof) may execute the machine-learned model 412 using all or part of the sensor data 204 as input. The output of the machine-learned model 412 may be and/or may indicate a sensor support level associated with the sensor data 204. At operation 706, an indication of the sensor support is provided to the planning system 250. At operation 708, the autonomy system 200 controls the autonomous vehicle 402 using the sensor support data 416. For example, the autonomy system 200 may modify a controlled device of the autonomous vehicle based at least in part on the sensor support data 416.

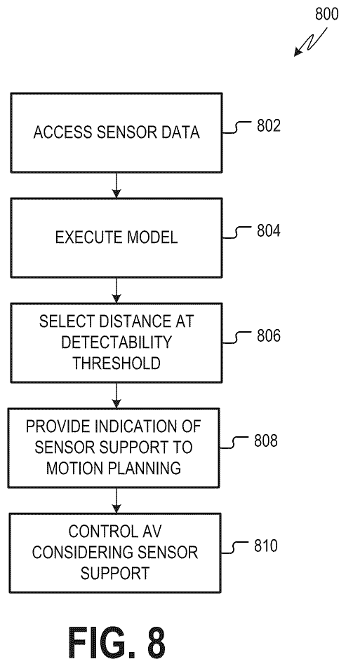

FIG. 8 is a flowchart showing one example of a process flow 800 that may be executed at the autonomous vehicle 402 (e.g. by the autonomy system 200 thereof) to operate the autonomous vehicle 404 considering sensor support data 416. In the example of FIG. 8, the output of the machine-learned model 412 comprises a predicted sensor support quantity for the reference object at a number of different ranges from the autonomous vehicle and/or sensor. For example, the output of the machine-learned model 412 may be similar to what is illustrated in TABLE 1 below:

TABLE 1

| | |
|---|---|
| Distance Bucket | Sensor Support Quantity |

| | | |
|---|---|---|
| 0-5 | Meters | Q1 |
| 5-10 | Meters | Q2 |
| 10-20 | Meters | Q3 |
| 20-30 | Meters | Q4 |
| 30-50 | Meters | Q6 |
| 50-100 | Meters | Q7 |

In TABLE 1, the output of the machine-learned model includes quantities for different distance buckets. In this example, the distance buckets include 0-5 m, 5-10 m, 10-20 m, 20-30 m, 30-50 m, and 50-100 m. It will be appreciated, however, that any suitable arrangement of distance buckets may be used. Arranging the machine-learned model to provide outputs for different distance buckets, as described herein, may improve the operation of the autonomous vehicle. For example, the planning system of the autonomous vehicle may utilize the bucket output by the machine-learned model to determine a motion plan for the autonomous vehicle, for example, with different levels of uncertainty based on objects detected in the different distance buckets.

At operation 802, the autonomy system 200 (e.g., the sensor support system 410 thereof) accesses sensor data 204. The sensor data 204 that is accessed may represent data generated over one sensing cycle. The sensor data 204 may include data generated by and having a single sensor and/or data generated by multiple sensors of different types and/or having different fields-of-view.

At operation 804, the autonomy system 200 (e.g., the sensor support system 410 thereof) may execute the machine-learned model 412 using all or part of the sensor data 204 as input. The output of the machine-learned model 412 may be and/or may indicate sensor support quantities over a range of distances, for example, as illustrated by TABLE 1 above. At operation 806, the autonomy system 200 (e.g., the sensor support system 410 thereof), based on the output of the machine-learned model, may select a distance at which the sensor support quantity meets a detectability threshold. At operation 808, the distance at which the sensor support quantity meets the detectability threshold may be provided to the planning system 250 as some or all of the sensor support data 416. In this way, the planning system 250 is provided with an estimate of the range at which it will detect actors and other objects as they approached the autonomous vehicle 402.

At operation 810, the autonomy system 200 controls the autonomous vehicle 402 using the sensor support data 416. For example, the autonomy system 200 may modify a controlled device of the autonomous vehicle based at least in part on the sensor support data 416.

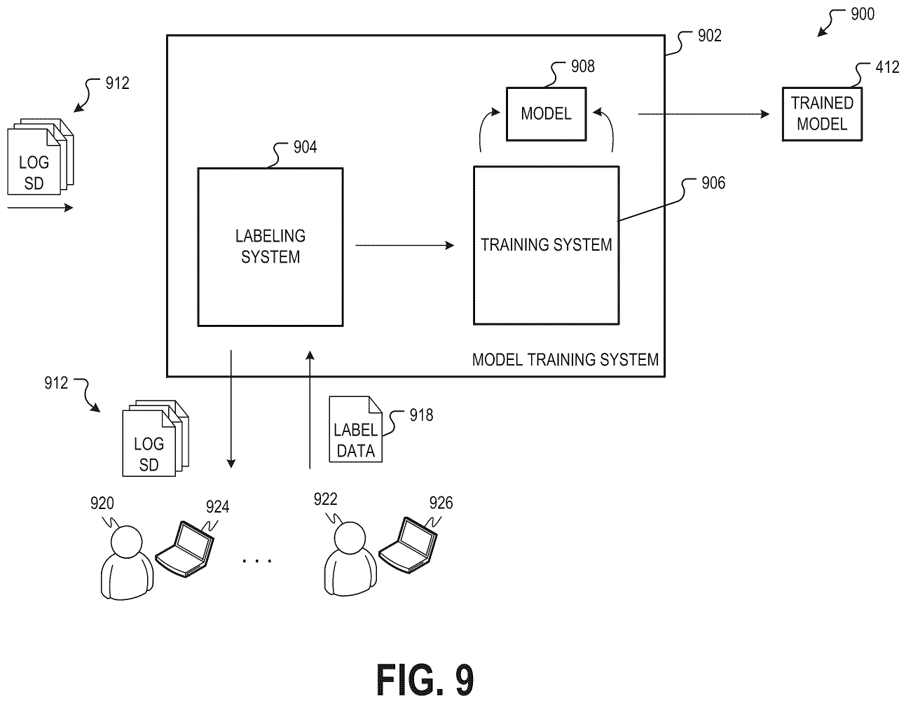

FIG. 9 is a diagram showing one example of an environment 900 for training the machine-learned model 412. The environment 900 comprises a model training system 902. The model training system 902 receives instances of logged sensor data 912. The instances of logged sensor data 912 includes sensor data captured by one or more reference vehicles during previously-executed trips. In some examples, the instances of logged sensor data 912 may be selected to encompass data captured during a variety of visibility conditions.

The instances of logged sensor data 912 are provided to a labeling system 904. The labeling system 904 may provide label data to be associated with each of the instances of logged sensor data 912. The label data for an instance of logged sensor data may indicate the presence of a reference object depicted by the instance. For example, the label data may indicate a portion of the sensor data that depicts the object.

The label data 918 may include, for example, a bounding box in two dimensions or three dimensions. The bounding box may indicate the location of the reference object. In some examples, the label data may be generated over multiple instances of the logged sensor data 912 captured by a common reference vehicle, for example, consecutively. Accordingly, a bounding box indicating the reference object may be expressed in for dimensions including, for example, three spatial dimensions and time. The label data for a logged sensor data instance may also indicate a distance of the reference object from the sensor that captured the logged sensor data. In some examples, the label data 918 may also indicate a visibility condition under which the corresponding instance of logged sensor data was captured.

In some examples, the labeling system 904 may automatically generate label data for the instances of logged sensor data 912. For example, the labeling system 904 may be programmed to identify instances of the reference object in the instances of the logged sensor data 912. In some examples, the labeling system 904 utilizes one or more human users 920, 922. For example, the labeling system 904 may provide some or all of the instances of logged sensor data 912 to respective human users 920, 922 via user computing devices 924, 926. In some examples, the instances of log sensor data 912 may be distributed among different human users 920, 922 with each human user 920, 922, receiving a subset of less than all of the instances of logged sensor data. The human users 920, 922 may view or otherwise analyze the instances of logged sensor data 912 and generate corresponding label data 918. The human users 920, 922 may provide the label data 918 to the labeling system 904. The labeling system may, in turn, provide the label data 918 to a training system 906 that may utilize the label data to train the machine-learned model 412.

The training system 906 may begin with an untrained version of the computerized model 908. The training system 906 may execute a number of training epochs utilizing the instances of the logged sensor data 912 and the generated label data 918 as training data. For each training epoch, the training system 906 may provide a portion of the logged sensor data 912 to the computerized model 908 as input. The computerized model 908 may generate an output predicting some or all of the label data 918 corresponding to the provided input. The training system may compare the label data 918 and the output of the computerized model 908 to determine an error. Based on the error, the training system 906 may modify the model. At the conclusion of the training epochs, the machine-learned model 412 may be generated.

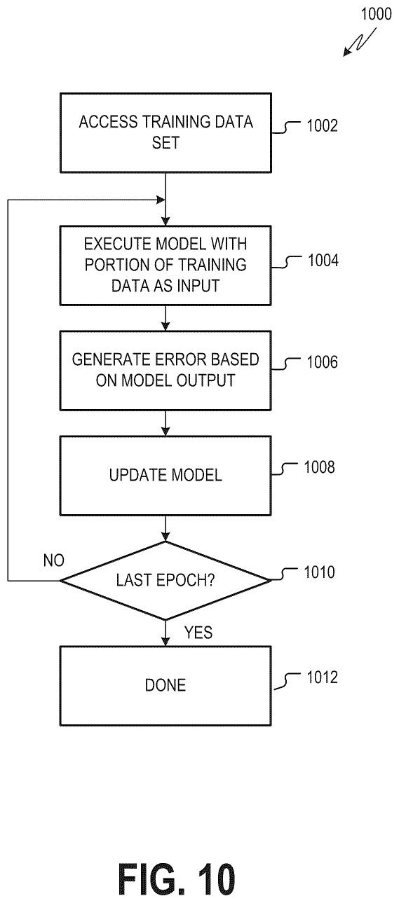

FIG. 10 is a flowchart showing one example of a process flow 1000 that may be executed in the environment 900 to train the machine-learned model 412. At operation 1002, the training system 906 may access a training data set. The training data set may comprise instances of logged sensor data 912 and corresponding label data 918. In examples where the output of the machine-learned model is an indication of a distance at which the reference object would meet the detectability threshold, the label data 918 may include an indication of the range at which the reference object was detected in a corresponding instance of the logged sensor data 912. In examples where the output of the machine-learned model is a visibility classification, the label data 918 may also indicate the visibility classification such as, for example, nominal, degraded, severely degraded, or another visibility condition selected from a range of visibility conditions as described herein.

At operation 1004, the training system 906 may execute the computerized model 908 with a portion of the training data as input. For example, one or more instances of the logged sensor data 912 may be used as input for the computerized model 908. The result may be an output of the computerized model 908. At operation 1006, the training system 906 may determine an error based on the output of the computerized model 908 from operation 1004. The error, in some examples, is or is based on a difference between the output of the computerized model 908 and the label data 918 describing the corresponding input to the computerized model 908. At operation 1008, the training system 906 may update the computerized model 908 based on the error determined at operation 1006. Any suitable technique may be used including, for example, a gradient descent technique.

At operation 1010, the training system 906 may determine if the current training epoch is the last training epoch. If the current training epoch is not the last training epoch, then the training system 906 may return to operation 1004 and re-execute the computerized model 908 with a next instance of the logged sensor data 912 as input. If the current training applicant is the last training epoch, then the training process may be completed at operation 1012. When the training process is completed, the current version of the computerized model 908 becomes the machine-learned model 412 as described herein.

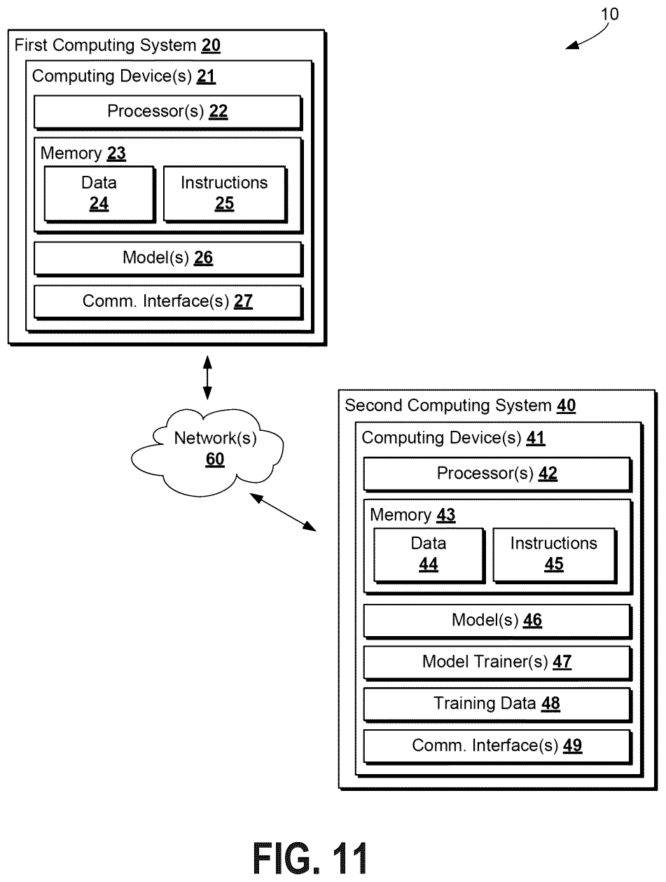

FIG. 11 is a block diagram of an example computing ecosystem 10 according to example implementations of the present disclosure. The example computing ecosystem 10 can include a first computing system 20 and a second computing system 40 that are communicatively coupled over one or more networks 60. In some implementations, the first computing system 20 or the second computing system 40 can implement one or more of the systems, operations, or functionalities described herein for data annotation (e.g., the remote system(s) 160, the onboard computing system(s) 180, the autonomy system 200, etc.).

In some implementations, the first computing system 20 can be included in an autonomous platform and be utilized to perform the functions of an autonomous platform as described herein. For example, the first computing system 20 can be located onboard an autonomous vehicle and implement autonomy system(s) for autonomously operating the autonomous vehicle. In some implementations, the first computing system 20 can represent the entire onboard computing system or a portion thereof (e.g., the localization system 230, the perception system 240, the planning system 250, the control system 260, or a combination thereof, etc.). In other implementations, the first computing system 20 may not be located onboard an autonomous platform. The first computing system 20 can include one or more distinct physical computing devices 21.

The first computing system 20 (e.g., the computing device(s) 21 thereof) can include one or more processors 22 and a memory 23. The one or more processors 22 can be any suitable processing device (e.g., a processor core, a microprocessor, an ASIC, a FPGA, a controller, a microcontroller, etc.) and can be one processor or a plurality of processors that are operatively connected. The memory 23 can include one or more non-transitory computer-readable storage media, such as RAM, ROM, EEPROM, EPROM, one or more memory devices, flash memory devices, etc., and combinations thereof.

The memory 23 can store information that can be accessed by the one or more processors 22. For instance, the memory 23 (e.g., one or more non-transitory computer-readable storage media, memory devices, etc.) can store data 24 that can be obtained (e.g., received, accessed, written, manipulated, created, generated, stored, pulled, downloaded, etc.). The data 24 can include, for instance, sensor data, map data, data associated with autonomy functions (e.g., data associated with the perception, planning, or control functions), simulation data, or any data or information described herein. In some implementations, the first computing system 20 can obtain data from one or more memory device(s) that are remote from the first computing system 20.

The memory 23 can store computer-readable instructions 25 that can be executed by the one or more processors 22. The instructions 25 can be software written in any suitable programming language or can be implemented in hardware. Additionally, or alternatively, the instructions 25 can be executed in logically or virtually separate threads on the processor(s) 22.

For example, the memory 23 can store instructions 25 that are executable by one or more processors (e.g., by the one or more processors 22, by one or more other processors, etc.) to perform (e.g., with the computing device(s) 21, the first computing system 20, or other system(s) having processors executing the instructions) any of the operations, functions, or methods/processes (or portions thereof) described herein. For example, operations can include generating boundary data for annotating sensor data, such as for implementing part of a training pipeline for machine-learned machine vision systems.

In some implementations, the first computing system 20 can store or include one or more models 26. In some implementations, the models 26 can be or can otherwise include one or more machine-learned models. As examples, the models 26 can be or can otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the first computing system 20 can include one or more models for implementing subsystems of the autonomy system 200, including any of: the localization system 230, the perception system 240, the planning system 250, or the control system 260.

In some implementations, the first computing system 20 can obtain the one or more models 26 using communication interface(s) 27 to communicate with the second computing system 40 over the network(s) 60. For instance, the first computing system 20 can store the model(s) 26 (e.g., one or more machine-learned models) in the memory 23. The first computing system 20 can then use or otherwise implement the models 26 (e.g., by the processors 22). By way of example, the first computing system 20 can implement the model(s) 26 to localize an autonomous platform in an environment, perceive an autonomous platform's environment or objects therein, plan one or more future states of an autonomous platform for moving through an environment, control an autonomous platform for interacting with an environment, etc.

The second computing system 40 can include one or more computing devices 41. The second computing system 40 can include one or more processors 42 and a memory 43. The one or more processors 42 can be any suitable processing device (e.g., a processor core, a microprocessor, an ASIC, a FPGA, a controller, a microcontroller, etc.) and can be one processor or a plurality of processors that are operatively connected. The memory 43 can include one or more non-transitory computer-readable storage media, such as RAM, ROM, EEPROM, EPROM, one or more memory devices, flash memory devices, etc., and combinations thereof.

The memory 43 can store information that can be accessed by the one or more processors 42. For instance, the memory 43 (e.g., one or more non-transitory computer-readable storage media, memory devices, etc.) can store data 44 that can be obtained. The data 44 can include, for instance, sensor data, model parameters, map data, simulation data, simulated environmental scenes, simulated sensor data, data associated with vehicle trips/services, or any data or information described herein. In some implementations, the second computing system 40 can obtain data from one or more memory device(s) that are remote from the second computing system 40.

The memory 43 can also store computer-readable instructions 45 that can be executed by the one or more processors 42. The instructions 45 can be software written in any suitable programming language or can be implemented in hardware. Additionally, or alternatively, the instructions 45 can be executed in logically or virtually separate threads on the processor(s) 42.

For example, the memory 43 can store instructions 45 that are executable (e.g., by the one or more processors 42, by the one or more processors 22, by one or more other processors, etc.) to perform (e.g., with the computing device(s) 41, the second computing system 40, or other system(s) having processors for executing the instructions, such as computing device(s) 21 or the first computing system 20) any of the operations, functions, or methods/processes described herein. This can include, for example, the functionality of the autonomy system 200 (e.g., localization, perception, planning, control, etc.) or other functionality associated with an autonomous platform (e.g., remote assistance, mapping, fleet management, trip/service assignment and matching, etc.).

In some implementations, the second computing system 40 can include one or more server computing devices. In the event that the second computing system 40 includes multiple server computing devices, such server computing devices can operate according to various computing architectures, including, for example, sequential computing architectures, parallel computing architectures, or some combination thereof.

Additionally, or alternatively to the model(s) 26 at the first computing system 20, the second computing system 40 can include one or more models 46. As examples, the model(s) 46 can be or can otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the second computing system 40 can include one or more models of the autonomy system 200.

In some implementations, the second computing system 40 or the first computing system 20 can train one or more machine-learned models of the model(s) 26 or the model(s) 46 through the use of one or more model trainers 47 and training data 48. The model trainer(s) 47 can train any one of the model(s) 26 or the model(s) 46 using one or more training or learning algorithms. One example training technique is backwards propagation of errors. In some implementations, the model trainer(s) 47 can perform supervised training techniques using labeled training data. In other implementations, the model trainer(s) 47 can perform unsupervised training techniques using unlabeled training data. In some implementations, the training data 48 can include simulated training data (e.g., training data obtained from simulated scenarios, inputs, configurations, environments, etc.). In some implementations, the second computing system 40 can implement simulations for obtaining the training data 48 or for implementing the model trainer(s) 47 for training or testing the model(s) 26 or the model(s) 46. By way of example, the model trainer(s) 47 can train one or more components of a machine-learned model for the autonomy system 200 through unsupervised training techniques using an objective function (e.g., costs, rewards, heuristics, constraints, etc.). In some implementations, the model trainer(s) 47 can perform a number of generalization techniques to improve the generalization capability of the model(s) being trained. Generalization techniques include weight decays, dropouts, or other techniques.

For example, in some implementations, the second computing system 40 can generate training data 48 according to example aspects of the present disclosure. For instance, the second computing system 40 can generate training data 48. The second computing system 40 can use the training data 48 to train model(s) 26. For example, in some implementations, the first computing system 20 can include a computing system onboard or otherwise associated with a real or simulated autonomous vehicle. In some implementations, model(s) 26 can include perception or machine vision model(s) configured for deployment onboard or in service of a real or simulated autonomous vehicle. In this manner, for instance, the second computing system 40 can provide a training pipeline for training model(s) 26.

The first computing system 20 and the second computing system 40 can each include communication interfaces 27 and 49, respectively. The communication interfaces 27, 49 can be used to communicate with each other or one or more other systems or devices, including systems or devices that are remotely located from the first computing system 20 or the second computing system 40. The communication interfaces 27, 49 can include any circuits, components, software, etc. for communicating with one or more networks (e.g., the network(s) 60). In some implementations, the communication interfaces 27, 49 can include, for example, one or more of a communications controller, receiver, transceiver, transmitter, port, conductors, software or hardware for communicating data.

The network(s) 60 can be any type of network or combination of networks that allows for communication between devices. In some implementations, the network(s) 60 can include one or more of a local area network, wide area network, the Internet, secure network, cellular network, mesh network, peer-to-peer communication link or some combination thereof and can include any number of wired or wireless links. Communication over the network(s) 60 can be accomplished, for instance, through a network interface using any type of protocol, protection scheme, encoding, format, packaging, etc.

FIG. 11 illustrates one example computing ecosystem 10 that can be used to implement the present disclosure. Other systems can be used as well. For example, in some implementations, the first computing system 20 can include the model trainer(s) 47 and the training data 48. In such implementations, the model(s) 26, 46 can be both trained and used locally at the first computing system 20. As another example, in some implementations, the computing system 20 may not be connected to other computing systems. Additionally, components illustrated or discussed as being included in one of the computing systems 20 or 40 can instead be included in another one of the computing systems 20 or 40.

Computing tasks discussed herein as being performed at computing device(s) remote from the autonomous platform (e.g., autonomous vehicle) can instead be performed at the autonomous platform (e.g., via a vehicle computing system of the autonomous vehicle), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks or operations can be performed sequentially or in parallel. Data and instructions can be stored in a single memory device or across multiple memory devices.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

What is claimed is:

1. A method of operating an autonomous vehicle, comprising:
accessing sensor data captured by at least one sensor corresponding to the autonomous vehicle associated with operation of the autonomous vehicle in an environment, the environment characterized by one or more environmental conditions;
generating, based on the sensor data and with a machine-learned model, an output that indicates a sensor support level in the environment, wherein the machine-learned model is trained using training data, the training data comprising a plurality of instances of logged sensor data depicting examples of a reference object, each instance of the plurality of instances of logged sensor data being associated with a label indicating a range at which the reference object was detected in the instances of logged sensor data, and wherein the reference object is not depicted in the sensor data captured by the at least one sensor; and
controlling the autonomous vehicle based at least in part on sensor support level.

2. The method of claim 1, further comprising:
selecting a distance from a plurality of distances having a corresponding sensor support quantity that meets a detectability threshold,
wherein the output of the machine-learned model comprises the plurality of sensor support quantities over a plurality of distances, a first sensor support quantity corresponding to the first distance of the plurality of distances and a second sensor support quantity corresponding to a second distance of the plurality of distances.

3. The method of claim 2, the sensor support quantity indicating at least one of a number of lidar points per unit surface area of the reference object that would be returned, a number of radar points per unit surface area of the reference object that would be returned, a result of applying an object detection mask to a portion of the sensor data depicting the reference object, or a result of a second machine-learned model that is trained to identify the reference object in at least a portion of the sensor data.

4. The method of claim 2, the detectability threshold indicating a threshold number of returned points per unit surface area of the reference object.

5. The method of claim 2, the sensor data comprising image data captured by a camera, the detectability threshold indicating a threshold result of applying an object detection mask to a portion of the image data.

6. The method of claim 2, the sensor data comprising image data captured by a camera, the detectability threshold indicating an output of a second machine-learned model trained to identify the reference object in the image data.

7. The method of claim 1, wherein the sensor support level comprises an indication of a visibility classification in the one or more environmental conditions.

8. The method of claim 7, wherein the visibility classification is one of nominal, degraded, or severely degraded.

9. The method of claim 1, further comprising:
executing the machine-learned model using at least a portion of the training data as input to generate a training output of the machine-learned model;
comparing the training output of the machine-learned model to the label data; and
modifying the machine-learned model based at least in part on the comparing of the training output of the machine-learned model to the label data.

10. The method of claim 8, each instance of the logged sensor data also being associated with label data indicating a visibility classification for the respective instance of the logged sensor data.

11. An autonomous vehicle comprising:
at least one processor programmed to perform operations comprising:
accessing sensor data captured by at least one sensor corresponding to the autonomous vehicle associated with operation of the autonomous vehicle in an environment, the environment characterized by one or more environmental conditions;
generating, based on the sensor data and a machine-learned model, an output that indicates a sensor support level in the environment, wherein the machine-learned model is trained using training data, the training data comprising a plurality of instances of logged sensor data depicting examples of a reference object, each instance of the plurality of instances of logged sensor data being associated with a label indicating a range at which the reference object was detected in the instances of logged sensor data, and wherein the reference object is not depicted in the sensor data captured by the at least one sensor; and
controlling the autonomous vehicle based at least in part on sensor support level.

12. The autonomous vehicle of claim 11, the operations further comprising selecting a distance from a plurality of distances having a corresponding sensor support quantity that meets a detectability threshold, wherein the output of the machine-learned model comprises the plurality of sensor support quantities over a plurality of distances, a first sensor support quantity corresponding to a first distance of the plurality of distances and a second sensor support quantity corresponding to the second distance of the plurality of distances.

13. The autonomous vehicle of claim 12, the sensor support quantity indicating at least one of a number of lidar points per unit surface area of the reference object that would be returned, a number of radar points per unit surface area of the reference object that would be returned, a result of applying an object detection mask to a portion of the sensor data depicting the reference object, or a result of a second machine-learned model that is trained to identify the reference object in at least a portion of the sensor data.

14. The autonomous vehicle of claim 12, the detectability threshold indicating a threshold number of returned points per unit surface area of the reference object.

15. The autonomous vehicle of claim 12, the sensor data comprising image data captured by a camera, the detectability threshold indicating an output of a second machine-learned model trained to identify the reference object in the image data.

16. The autonomous vehicle of claim 12, the sensor data comprising image data captured by a camera, the detectability threshold indicating an output of a second machine-learned model trained to identify the reference object in the image data.

17. The autonomous vehicle of claim 11, wherein the sensor support level comprises an indication of a visibility condition in the environment.

18. The autonomous vehicle of claim 11, the operations further comprising:
executing the machine-learned model using at least a portion of the training data as input to generate a training output of the machine-learned model;
comparing the training output of the machine-learned model to the label data; and
modifying the machine-learned model based at least in part on the comparing of the training output of the machine-learned model to the label data.

19. The autonomous vehicle of claim 17, each instance of the logged sensor data also being associated with label data indicating a visibility classification for the respective instance of the logged sensor data.

20. At least one non-transitory computer-readable storage media comprising instructions thereon that, when executed by at least one processor, because the at least one processor to perform operations comprising:
accessing sensor data captured by at least one sensor corresponding to an autonomous vehicle associated with operation of the autonomous vehicle in an environment, the environment characterized by one or more environmental conditions;
generating, based on the sensor data and a machine-learned model, an output that indicates a distance at which a reference object would meet a detectability threshold in the environment; and
controlling the autonomous vehicle based at least in part on the distance or a visibility classification derived from the distance.
